(19) United States
(12) Patent Application Publication
(10) Pub. No.: US 2025/0104028 A1
(43) Pub. Date: Mar. 27, 2025

(54) EMERGENCY RECOVERY TRANSACTION OF FUNDS OF CRYPTO CURRENCY WALLET

(71) Applicant: BLOCKDAEMON APS, Aarhus (DK)

(72) Inventors: Thomas Pelle JAKOBSEN, Marslet (DK); Jakob Illeborg PAGTER, Aarhus V (DK); Jesper Buus NIELSEN, Aarhus C (DK); Tomas Friis TOFT, Hinnerup (DK); Michael Baeksvang OSTERGAARD, Hasselager (DK)

(21) Appl. No.: 18/729,579

(22) PCT Filed: Jan. 20, 2023
(86) PCT No.: PCT/EP2023/051324

§ 371 Date: Jul. 17, 2024

(30) Foreign Application Priority Data
Jan. 21, 2022 (EP) 22152701.3

(51) Int. Cl. G06Q 20/06; G06Q 20/36; G06Q 20/38

(52) U.S. Cl. CPC G06Q 20/0658; G06Q 20/36; G06Q 20/3829

(57) ABSTRACT

A method for performing an emergency recovery transaction of funds of a crypto currency wallet involves a distributed cryptographic key shared among two or more nodes with each node holding a share of the cryptographic key and none of the nodes holding the entire cryptographic key. The cryptographic key provides access to the funds of the crypto currency wallet. Recovery information regarding the cryptographic key is stored in a storage being separate from the two or more nodes. If the cryptographic key and/or the wallet becomes in-operational, a user retrieves the recovery information from the storage and provides at least part of the retrieved recovery information to an emergency recovery service. The emergency recovery service and the user perform an emergency recovery transaction of funds from the crypto currency wallet to a new crypto currency wallet, based on the recovery information.

### FIELD OF THE INVENTION

The present invention relates to a method for performing an emergency recovery transaction of funds of a crypto currency wallet. More specifically, the method according to the invention allows a user access to crypto currency funds in the case that the crypto currency wallet and/or a cryptographic key providing access to the crypto currency wallet becomes in-operational.

### BACKGROUND OF THE INVENTION

Crypto currency, such as bitcoins, are normally held in a digital ‘wallet’, in the form of one or more digital addresses. When performing transactions of the crypto currency, funds are moved to a new address by means of blockchain technology. In order to perform a transaction, a user needs to apply a personal cryptographic key.

The personal cryptographic key may be stored at one or more devices under the direct control of the owner of the personal cryptographic key, such as personal computers, tablets, cell phones, dongles, etc. Alternatively, the personal cryptographic key may be managed by a trusted key management service. In this case the personal cryptographic key is stored at one or more servers or one or more nodes being under the control of the trusted key management service. In any event, the personal cryptographic key may be stored in its entirety at a single position, or it may be stored in a distributed or shared manner among two or more nodes.

In the case that the crypto currency wallet and/or the personal cryptographic key becomes in-operational, it will no longer be possible for the owner of the crypto currency to gain access to the funds of the crypto currency wallet. The crypto currency wallet and/or the personal cryptographic key may, e.g., become in-operational by the device(s), server(s), node(s), etc., where the wallet and/or the personal cryptographic key is/are stored being stolen or physically destroyed or damaged.

US 2019/0007205 A1 discloses a system and method for persona management in online environments. An identity proxy with trusted parties has portions of a private cryptographic key of a consumer so that the private cryptographic key of the consumer may be re-generated or recovered in the case that the private cryptographic key held by the consumer is lost or destroyed. The owner of a lost wallet may retrieve the shares of their private key from the trusted parties after their identity is verified using a new wallet. When the new wallet is created, the key recovery engine can be used to initiate the recovery of the private key from the retrieved key shares. Thus, the entire key is recovered at a device held by the consumer.

### DESCRIPTION OF THE INVENTION

It is an object of embodiments of the invention to provide a method which allows emergency recovery of funds from a crypto currency wallet in a safe and trustworthy manner.

The invention provides a method for performing an emergency recovery transaction of funds from a crypto currency wallet, the method comprising the steps of:
providing a distributed cryptographic key being shared among two or more nodes with each node holding a share of the cryptographic key and none of the nodes holding the entire cryptographic key, the cryptographic key providing access to the funds of the crypto currency wallet,
storing recovery information regarding the cryptographic key in a storage being separate from the two or more nodes,
in the case that the cryptographic key and/or the wallet becomes in-operational, a user retrieving the recovery information from the storage and providing at least part of the retrieved recovery information to an emergency recovery service, and
the emergency recovery service and the user in cooperation performing an emergency recovery transaction of funds from the crypto currency wallet to a new crypto currency wallet, based on the recovery information.

Thus, the invention relates to a method for performing an emergency transaction of funds from a crypto currency wallet. In the present context, the term ‘crypto currency wallet’ should be interpreted to mean a system which is associated with a user and with crypto currency funds belonging to that user, including one or more digital addresses and associated private keys.

In the present context, the term ‘emergency recovery transaction’ should be interpreted to mean a transaction which allows the user access to the funds of the crypto currency wallet once, e.g. in order to move the funds to a new wallet, such as to one or more new digital addresses, in the case that the wallet and/or a private cryptographic key of the user which normally provides access to the crypto currency wallet becomes in-operational.

In the method according to the invention, a distributed cryptographic key is initially provided, and the cryptographic key provides access to the funds of the crypto currency wallet, i.e. the cryptographic key is associated with the crypto currency wallet and forms a private key of the user owning the funds of the crypto currency wallet. The distributed cryptographic key is shared among two or more nodes with each node holding a share of the cryptographic key and none of the nodes holding the entire cryptographic key. Accordingly, access to the crypto currency wallet requires information or knowledge held by two or more of the nodes, possibly by all of the nodes, and it is not possible to gain unauthorised access to the funds of the crypto currency wallet by compromising only one of the nodes.

Thus, the cryptographic key applied when performing the method according to the invention is of a kind which is distributed or shared among two or more nodes. Such a cryptographic key provides a higher security level than a cryptographic key which is stored at a single node or device, because there is no single point of trust.

In the present context the term ‘node’ should be interpreted to mean a digital position with storage capability, which is separate from the other nodes. The nodes may, e.g., be in the form of servers, separate parts of a server, various devices, such as cell phone, personal computer, dongle, etc., or any combination of the above.

Next, recovery information regarding the cryptographic key is stored in a storage which is separate from the two or more nodes. Thus, in the case that one or more of the nodes is compromised, physically destroyed or damaged, or in any other way becomes in-operational, the recovery information relating to the cryptographic key will still be available. Furthermore, a malicious party who gains access to a given node, and possibly corrupts the share held by that node, will not have access to the corresponding recovery information, and the recovery information thereby remains un-corrupted.

The separate storage may be an offline storage or a so-called ‘cold storage’. In this case it is not possible to gain access to the storage, and thereby to the recovery information, via online communication channels, e.g. via the Internet, and thereby the risk of unauthorised access to the recovery information is minimised.

In the present context, the term ‘recovery information’ should be interpreted to mean information which allows at least partly recovery of the cryptographic key, at least to the extent where access to the funds of the crypto currency wallet is possible. This will be described in further detail below. The recovery information may provide separate information regarding the shares held by each of the nodes. As an alternative, the recovery information could, e.g., be in the form of a multiparty encrypted version of the cryptographic key, which is generated by the nodes in cooperation by means of a multiparty encryption process, such as secure multiparty computation (MPC).

In the case that the cryptographic key and/or the wallet becomes in-operational, a user retrieves the recovery information from the storage and provides at least part of the retrieved recovery information to an emergency recovery service.

In the present context the term ‘in-operational’ should be interpreted to cover situations where it is no longer possible to gain access to the funds of the crypto currency wallet, e.g. because the cryptographic key or the wallet has been compromised or corrupted, because one or more devices holding shares of the cryptographic key has been stolen or otherwise lost, or because one or more nodes holding shares of the cryptographic key has been physically destroyed or damaged, e.g. due to fire or explosion.

In the present context the term ‘emergency recovery service’ should be interpreted to mean a service provider, which is capable of at least partly recovering the cryptographic key, or a representation of the distributed cryptographic key, such as the shares of the cryptographic key, based on the part of the relevant recovery information which was provided by the user, and possibly applying further information provided by the user and/or in cooperation with the user.

Accordingly, the emergency recovery service and the user finally perform, in cooperation, an emergency recovery transaction of funds from the crypto currency wallet to a new crypto currency wallet, based on the recovery information.

Thereby it is ensured that the funds of the crypto currency wallet, which had become inaccessible to the user due to the cryptographic key and/or the wallet being in-operational, is once again accessible to the user at the new crypto currency wallet. Furthermore, since the emergency recovery transaction was performed based on the recovery information, which was retrieved from the storage and provided to the emergency recovery service by the user, it is ensured that only a user with appropriate access to the storage, and thereby to the relevant recovery information, can initiate the emergency recovery transaction. Thereby the risk of unauthorised access to the recovered funds of the crypto currency wallet is minimised.

The emergency recovery transaction may be performed solely by the emergency recovery service, but based on information provided by the user. This information may simply be the recovery information, but it could alternatively include additional information, such as information proving the identity of the user, information related to or identifying the crypto currency wallet, etc. As an alternative, the emergency recovery transaction may require interaction between the emergency recovery service and the user. For instance, the user and the emergency recovery service may perform secure multiparty computation in order to perform the emergency recovery transaction. As another alternative, the emergency recovery transaction may be performed by the user, based on an output generated by the emergency recovery service, based on the recovery information. Such an output may, e.g., include a recovered version of the cryptographic key.

In any event, the emergency recovery transaction is performed by the emergency recovery service and the user in cooperation, in the sense that neither the emergency recovery service nor the user will be able to perform the emergency recovery transaction on their own, i.e. without the participation of the other party. Thus, neither the emergency recovery service nor the user constitutes a single point of trust, and this significantly improves the safety and trustworthiness of the system and method. In particular, neither the emergency recovery service nor the user gains knowledge of the entire cryptographic key during the emergency recovery transaction.

For example, the recovery transaction protocol applied for performing the emergency recovery transaction may involve the user and the emergency recovery service together running an interactive Secure Multiparty Computation (MPC) protocol. When running the MPC protocol, the following may happen:
(1) the user uses the, possibly encrypted, recovery information as input in the protocol and the emergency recovery service uses a decryption key as input in the protocol, where the decryption key can be used for decrypting the recovery information in order to regenerate the cryptographic key;
(2) in the MPC protocol the recovery information is then decrypted using the decryption key;
(3) in the MPC protocol an emergency transaction is signed using the decrypted/regenerated cryptographic key; and
(4) the output of the MPC protocol is the emergency transaction which is now signed with the cryptographic key.

Using secure multiparty computation to decrypt the encrypted recovery information, obtain the cryptographic key, and sign the emergency transaction with the cryptographic key, ensures that neither the user nor the emergency recovery service at any point learns the decrypted cryptographic key, and thus there is no single point of trust. For example, a single corruption of either the user or the emergency recovery service alone at the time of the recovery operation is not sufficient to control the destination of the emergency transaction and thereby steal the funds. As long as at least one of the two parties remains honest, the secure multiparty computation guarantees that the emergency transaction will correctly transfer the funds to the new destination wallet.

The step of the emergency recovery service and the user in cooperation performing an emergency recovery transaction may comprise the steps of:
the emergency recovery service generating a one-time cryptographic transaction key, based on the received recovery information, and
the emergency recovery service performing an emergency recovery transaction of funds from the crypto currency wallet to a new crypto currency wallet, using the one-time cryptographic transaction key.

According to this embodiment, the emergency recovery service applies the recovery information received via the user for generating a one-time cryptographic transaction key, which can be used for gaining access to the contents of the crypto currency wallet, at least to the extent that the emergency transaction to the new crypto currency wallet can be performed. After the emergency transaction has been performed, the one-time cryptographic transaction key can no longer be used, including being used for gaining access to the new crypto currency wallet, and thereby to the funds of the wallet. Therefore it is not critical if the one-time cryptographic transaction key leaks after the emergency transaction.

The one-time cryptographic transaction key may, e.g., be a recovered version of the cryptographic key. In this case it is necessary to generate a new distributed cryptographic key once the funds have been transferred to the new crypto currency wallet. It is noted that moving funds to a new crypto currency wallet will normally require a new key pair (public and private) to be generated, and the new public key will be linked to the address of the new wallet.

As an alternative, the emergency recovery service may, based on the recovery information, generate information which enables the user to recover the cryptographic key or a one-time cryptographic transaction key. In this case the user may subsequently perform the emergency transaction, based on the information provided by the emergency recovery service. According to this embodiment the emergency recovery service will not come into possession of the cryptographic key.

As another alternative, the emergency recovery service and the user may cooperate in performing the emergency recovery transaction, e.g. using secure multiparty computation (MPC). In this case neither the emergency recovery service, nor the user is enabled to perform the emergency transaction alone. Furthermore, neither the emergency recovery service, nor the user comes into the possession of the cryptographic key.

The recovery information may be in the form of pre-signatures generated by the nodes based on the shares of the cryptographic key held by the nodes. According to this embodiment, the nodes generate pre-signatures, using the shares of the cryptographic key, and these pre-signatures are exported and stored in the separate storage. When an emergency transaction is required, a signature is generated based on the pre-signatures, and this signature is applied for performing the emergency transaction. The computation performed when computing a digital signature can often be divided into two steps, where the data produced in the first step is required by the last step, and where the last step results in the final digital signature. In the present context the term ‘pre-signature’ should be interpreted to mean the data produced in the first step.

For example, the cryptographic key x may be a private signing key for the ECDSA digital signature scheme, and the pre-signature may be the values (g^{k}, k, x·k⁻¹) for a random nonce k. Possession of such a pre-signature reduces the amount of computation required to produce the final signature. The nodes may for example, based on their secret sharing of x, produce a secret sharing of the pre-signature using secure multiparty computation, and the recovery information may consist of encrypted shares of the pre-signature.

The step of the user providing at least part of the retrieved recovery information to the emergency recovery service may comprise the step of proving the identity of the user towards the emergency recovery service.

According to this embodiment, the emergency recovery service only participates in the emergency recovery transaction if it can be verified that the user providing the retrieved recovery information to the emergency recovery service is in fact the rightful owner of the recovery information, and thereby the cryptographic key. This reduces the risk of a malicious party, who has gained access to the recovery information, also gains access to the funds of the crypto currency wallet.

The recovery information may comprise information regarding a unique identity of the user, and the step of proving the identity of the user towards the emergency recovery service may comprise the step of the user proving ownership of the unique identity.

According to this embodiment, when the recovery information is generated, information regarding the unique identity of the user is added to the recovery information, or integrated into the recovery information. This allows the emergency recovery service to readily verify whether or not a unique identity presented by a user, who is also providing the recovery information, matches the unique identity forming part of the recovery information.

The unique identity may be cryptographically linked to the recovery information. According to this embodiment, the unique identity, e.g. in the form of a user identity string (UID), forms an integral part of the recovery information.

For instance, the recovery information may comprise a zero-knowledge proof which includes the unique identity of the user. The zero-knowledge proof could, e.g., be made non-interactive using the Fiat-Shamir transform, and the unique identity of the user, UID, may be included in the challenge that is hashed. According to this embodiment, the emergency recovery service will be able to verify that the identity of the user is the same identity that was used when the nodes generated the zero-knowledge proof. This, in turn, ensures that an emergency transaction is only performed based on recovery data that belongs to the user.

As an alternative, the user identity may be linked to the recovery information using a digital signature. For instance, the nodes may perform a multiparty process, in which they agree on an entity, s. In the case there are three nodes, s may be defined as:

s=c1∥c2∥c3∥UID,

where c1, c2 and c3 represent recovery information originating from the respective three nodes, UID is the unique identity of the user, and ∥ is string concatenation. Next, the nodes may use a threshold signature scheme to produce a signature, σ=signₛₖ(s), using a shared cryptographic signing key (sk). s and o may then be provided to the user and/or to the emergency recovery service. The emergency recovery service will then, given the public verification key of the threshold signature scheme, vk, be able to verify that the signature, σ, is valid and that the user's identity matches the value UID included in s. This will prove to the emergency recovery service that the recovery data was produced by the nodes holding the secret key sk, and that the recovery information belongs to the user.

The method may further comprise the steps of:
the two or more nodes providing encrypted versions of their shares of the cryptographic key to each other, and
the two or more nodes verifying the encrypted shares of the cryptographic key,
   and the step of storing recovery information regarding the cryptographic key in the storage may comprise each of the nodes providing the encrypted version of its share of the cryptographic key to the storage in the case that the zero-knowledge proofs are valid.

According to this embodiment, the nodes perform a multiparty verification process, in which they validate the encrypted versions of their respective shares of the cryptographic key. This may, e.g., be done by means of zero-knowledge proofs, and thereby without any of the nodes gaining knowledge of or coming into the possession of the shares held by the other nodes. However, the user can ensure that the encrypted shares of the cryptographic key are correct and un-corrupted before they are provided as recovery information to the storage.

An example of this embodiment is as follows: Assume that each node holds the public encryption key ek and the emergency recovery service holds the corresponding private decryption key dk for a public-key encryption scheme. Assume also that the cryptographic key is a private ECDSA or EdDSA signing key. Each node then encrypts its share xi of the cryptographic key x using ek and sends the encrypted key share to all the other nodes together with a cryptographic Feldman commitment to the share, g^{xi}, and a non-interactive zero-knowledge proof that the commitment is a commitment to the same value that was encrypted. When a node receives a commitment and an encryption from another node, it validates the zero-knowledge proof. Once a node has received encrypted values and commitments from all other nodes, and they are all found to be valid, the node sends all encrypted values and commitments, including its own encryption and commitment, to the user. The user then validates all the received encryptions and commitments by comparing each commitment and encryption received from a node with the corresponding commitment and encryption received from the other nodes. Finally, the user combines the commitments into a commitment of the cryptographic key, Y=g^{x1}·g^{x2} . . . g^{xn}, where n is the number of nodes, and the user validates that Y is indeed the correct public key corresponding to the private cryptographic key x.

It is an advantage of this embodiment that all zero-knowledge proofs are generated and validated by the nodes, i.e. before the encrypted shares leave the nodes. The user can validate the recovery information simply by comparing values and multiply the Feldman commitments, which are ordinary points on the ECDSA or EdDSA elliptic curve.

As an alternative, the method may further comprise the step of the two or more nodes creating an encrypted version of the cryptographic key, based on the shares of the cryptographic key and using a multiparty encryption process, and the step of storing recovery information regarding the cryptographic key in the storage may comprise storing the encrypted version of the cryptographic key in the storage.

According to this embodiment, the recovery information being stored is an encrypted version of the entire cryptographic key, rather than information related to the individual key shares. The encrypted version of the cryptographic key is created by means of a multiparty encryption process, such as secure multiparty computation (MPC), performed by the nodes.

The cryptographic key may, e.g., be encrypted by means of a separate public-key encryption key which is available to the nodes. The corresponding decryption key may be available at the emergency recovery service, thereby enabling the emergency recovery service to decrypt the encrypted version of the cryptographic key in the case that the cryptographic key and/or the wallet has become in-operational, and an emergency recovery transaction of funds from the crypto currency wallet is therefore required. This might expose the cryptographic key to the emergency recovery service. However, this may be regarded as acceptable, since the transaction is an emergency transaction, and a new cryptographic key can be generated for the new crypto currency wallet.

The encrypted version of the cryptographic key may comprise a zero-knowledge proof, and the step of storing recovery information regarding the cryptographic key in the storage may comprise verifying the zero-knowledge proof prior to storing the encrypted version of the cryptographic key.

According to this embodiment, it is ensured that the encrypted version of the cryptographic key, and thereby the recovery information being stored, is correct and un-corrupted before it is stored. Thereby it is ensured that, if an emergency transaction is required, it will in fact be possible to perform the emergency transaction, based on the stored recovery information. Since the verification is performed by means of a zero-knowledge proof, leaking of any information regarding the cryptographic key or the individual shares of the cryptographic key is prevented.

For instance, if the encrypted version of the cryptographic key was not correctly generated, e.g. if there was malicious activity when generating the encrypted version, the owner of the lost wallet may not be able to recover the original cryptographic key (e.g., because some or all of the encrypted portions were corrupted before encryption). Contrary to this, in some of the embodiments of the present invention, it is possible for the wallet user (or anyone else) at any time to validate that the encrypted version of the cryptographic key is correct, thus ensuring that it will indeed be possible to later recover the cryptographic key. Accordingly, it is ensured, using cryptographic zero-knowledge techniques, that this validation can be done by anyone, even by parties that are not able to decrypt the encrypted portions.

The method may further comprise the step of providing a master chain code and storing the master chain code at the two or more nodes, and the step of storing recovery information regarding the cryptographic key in the storage may comprise storing an encrypted version of the master chain code as part of the recovery information.

In some crypto currency standards, e.g. BIP-32, a cryptographic master key as well as a master chain code may be derived from a master seed, and the cryptographic master key and the master chain code may, in combination, be used for deriving subsequent cryptographic keys to be used for transactions of crypto currency. In this case, it may be relevant to store recovery information related to the cryptographic master key as well as related to the master chain code. Thereby it will be possible to restore information required in order to generate cryptographic transaction keys, and thereby to perform an emergency transaction of the funds of the crypto currency wallet.

Each of the nodes may hold the entire master chain code. As an alternative, the master chain code may be distributed among the nodes, e.g. secret shared among the nodes, similar to the shared cryptographic key.

As described above, the distributed cryptographic key and the master chain code may be derived from a common master seed, and the step of storing recovery information may comprise storing an encrypted version of the common master seed. According to this embodiment, the master cryptographic key as well as the master chain code can be derived from the recovery information.

The method may further comprise the step of the user verifying the retrieved recovery information by verifying correspondence between the cryptographic key and the master chain code.

According to this embodiment, the user verifies that the recovery information retrieved from the storage is in fact correct and un-corrupted before it is supplied to the emergency recovery service. The verification may, e.g., be performed by means of a zero-knowledge proof.

For instance, in the case that the recovery information comprises information regarding the cryptographic key as well as a master chain code, the zero-knowledge proof may verify that key derivation using the cryptographic key and the master chain code corresponds to two public keys provided by the user. Alternatively or additionally, the zero-knowledge proof may verify that applying a correct key derivation on the common master seed yields the cryptographic key that corresponds to a public key provided by the user.

### BRIEF DESCRIPTION OF THE DRAWINGS

The invention will now be described in further detail with reference to the accompanying drawings in which

FIG. 1 is a diagram illustrating a method according to an embodiment of the invention,

FIG. 2 is a block diagram illustrating a system for storing recovery information as part of performing a method according to an embodiment of the invention,

FIG. 3 is a block diagram illustrating a system for performing an emergency recovery transaction based on recovery information as part of performing a method according to an embodiment of the invention,

FIG. 4 illustrates storing of recovery information as part of performing a method according to an embodiment of the invention,

FIG. 5 illustrates an emergency recovery transaction in accordance with a method according to an embodiment of the invention,

FIG. 6 illustrates storing of recovery information as part of performing a method according to an alternative embodiment of the invention,

FIG. 7 illustrates an emergency recovery transaction in accordance with a method according to an alternative embodiment of the invention, and

FIG. 8 illustrates recovery data generation using secure multiparty computation (MPC), in accordance with an embodiment of the invention.

### DETAILED DESCRIPTION OF THE DRAWINGS

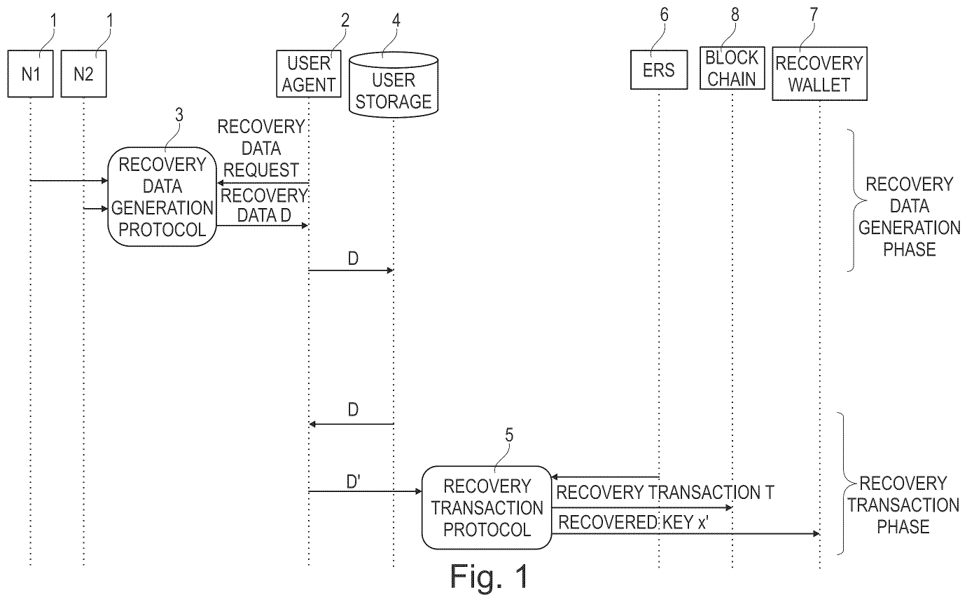

FIG. 1 is a diagram illustrating a method according to an embodiment of the invention. A distributed cryptographic key, which provides access to the funds of a crypto currency wallet, is shared among a number of nodes 1. Accordingly, each of the nodes 1 holds a share of the cryptographic key, but none of the nodes 1 is in the possession of or has knowledge of the entire cryptographic key. In FIG. 1 two nodes 1 are shown, but it should be noted that it is within the scope of the present invention to apply three or more nodes 1.

A user agent 2 requests recovery information, D, regarding the shares of the cryptographic key from the nodes 1, and the nodes 1 provide the requested recovery information, D, to the user agent 2 by applying a protocol 3. The protocol may be interactive, and it may require several rounds of communication between the nodes 1 and the user agent 2. The recovery information, D, could be in the form of information regarding each of the shares held by the nodes 1, or it could be in the form of a multiparty generated secret or cryptographic version of the distributed cryptographic key.

The user agent 2 ensures that the recovery information, D, is stored in a storage 4 which is separate from the nodes 1. The storage 4 may, e.g., be a cold storage, i.e. a storage which is not accessible via a communication network, such as the Internet. In this case, the user agent 2 may physically carry an offline storage medium, such as a USB stick, with the recovery information to the storage 4.

In the case that the cryptographic key and/or the wallet becomes in-operational, the user agent 2 retrieves the recovery information, D, from the storage 4, and initiates an emergency recovery procedure, including applying a recovery transaction protocol 5. This includes supplying a version of the recovery information, D′, to the transaction protocol 5. The version of the recovery information, D′, which is supplied to the transaction protocol 5, may simply be the recovery information, D, which was stored in the storage 4, i.e. D=D′. Alternatively, it may be a modified version of the stored recovery information, D, e.g. an encrypted version, a version which includes further information provided by the user agent 2, or only a part of the recovery information, D.

The emergency recovery procedure includes providing the recovery information, D′, to an emergency recovery service 6. The user agent 2 and the emergency recovery service 6 then cooperate in performing an emergency transaction of funds from a crypto currency wallet to a new crypto currency wallet 7, by means of the recovery transaction protocol 5, and by posting the transaction to a blockchain network 8.

The emergency transaction may take place in several ways. For instance, the emergency recovery service 6 or the user agent 2 may receive a signed recovery transaction as output of the recovery transaction protocol 5, which the emergency recovery service 6 or the user agent 2 subsequently posts to the blockchain network 8. The posting may happen due to the emergency recovery service 6 or the user agent 2 running itself a blockchain node, or via a third party to which the transaction is delivered. As an alternative, the recovery transaction protocol 5 may result in the user agent 2 and the emergency recovery service 6 each holding only an encrypted or secret shared version of the recovered transaction, and the posting of the transaction to the blockchain network 8 may involve a more advanced protocol.

The new crypto currency wallet 7 may be a standard crypto currency wallet, or it may be a threshold wallet comprising several wallet nodes.

The emergency recovery procedure may include recovering the original cryptographic key, i.e. the cryptographic key which was distributed among the nodes 1. In this case, the user agent 2 and/or the emergency recovery service 6 may temporarily learn or gain knowledge of the original cryptographic key as part of the recovery transaction protocol 5, and a new cryptographic key is therefore required in order to gain access to the new crypto currency wallet 7. As an alternative, the recovery transaction protocol 5 may ensure that the original cryptographic key is not revealed in the clear, but only in an encrypted or secret shared form.

According to the embodiment illustrated in FIG. 1, the new crypto currency wallet obtains the new cryptographic key x′ as a result of the recovery transaction protocol. The key x′ may be generated by the user, or by the emergency recovery service and sent to the new crypto currency wallet. Alternatively, x′ may be generated by the new crypto currency wallet, and only the corresponding public key Y may be revealed to the user and/or the emergency recovery service. Alternatively, x′ may be generated using a multiparty process between the user, the emergency recovery service and/or the new crypto currency wallet. In any case, the result of the emergency recovery is that the new cryptographic key x′ is stored by the new crypto currency wallet.

The generation of the recovery information, D, and the emergency recovery procedure may be temporally separated, i.e. the emergency recovery procedure may take place a long time after the recovery information, D, was generated and stored in the storage 4. Furthermore, the user agent 2 which receives the recovery information, D, from the nodes 1 and stores it in the storage 4 need not be the same user agent 2 which retrieves the recovery information, D, from the storage 4 and initiates the emergency recovery procedure. For instance, the two processes may be performed from two different devices.

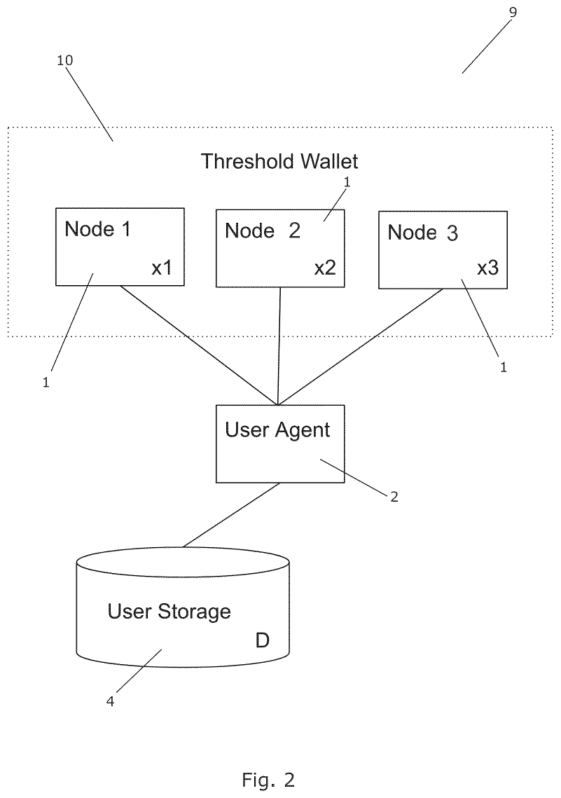

FIG. 2 is a block diagram illustrating a system 9 for use in performing part of a method according to an embodiment of the invention. More specifically, the system 9 illustrated in FIG. 2 may be used for generating and storing recovery information regarding shares of a distributed cryptographic key.

The system 9 comprises a crypto currency wallet 10. A distributed cryptographic key, x, is shared among a number of nodes 1, such that an i'th node 1 holds a share, xᵢ, of the cryptographic key x. In FIG. 2, three nodes 1 are shown. However, it should be noted that it is within the scope of protection of the present invention that the system 9 comprises two nodes 1 or four or more nodes 1.

A user agent 2 obtains recovery information, D, regarding the shares, xᵢ, of the cryptographic key, x, from the nodes 1, and stores the recovery information, D, in a storage 4, which is separate from the nodes 1. This may, e.g., be done in the manner described above with reference to FIG. 1.

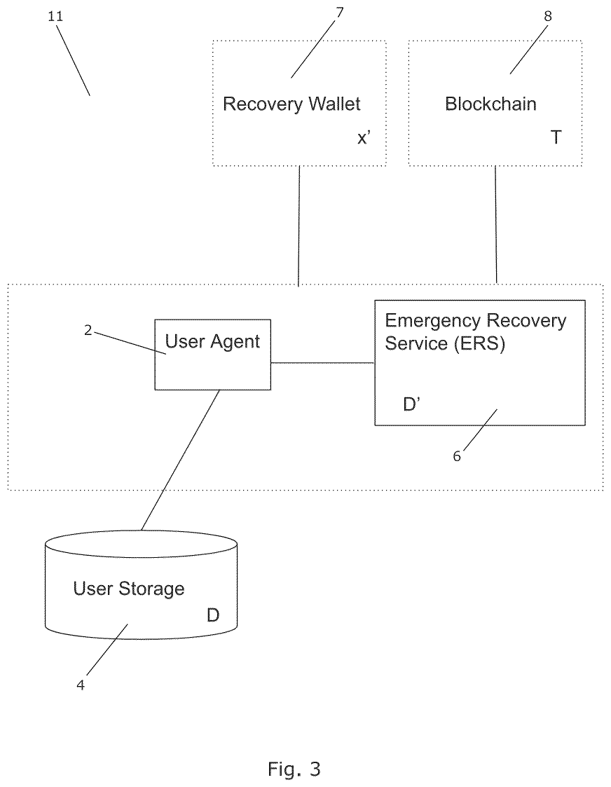

FIG. 3 is a block diagram illustrating a system 11 for use in performing part of a method according to an embodiment of the invention. More specifically, the system 11 of FIG. 3 may be used for performing an emergency recovery transaction of the funds of a crypto currency wallet.

A user agent 2 retrieves recovery information, D, from a storage 4, where it was previously stored, e.g. in the manner described above with reference to FIGS. 1 and 2. The user agent 2 provides a version of the retrieved recovery information, D′, to an emergency recovery service 6. As described above with reference to FIG. 1, the version of the recovery information, D′, which is provided to the emergency recovery service 6 may be identical to the recovery information, D, which was stored in the storage 4 and subsequently retrieved by the user agent 2, or it may be a modified version.

The user agent 2 and the emergency recovery service 6 cooperate in performing an emergency recovery transaction which results in the funds from the crypto currency wallet being transferred to a new crypto currency wallet 7 by posting the transaction to a blockchain network 8. This may, e.g., be done in the manner described above with reference to FIG. 1.

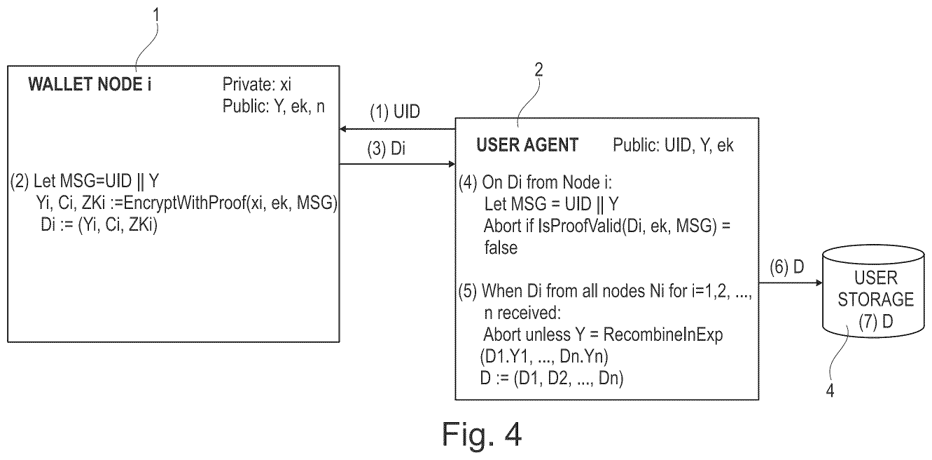

FIG. 4 illustrates storing of recovery information as part of performing a method according to an embodiment of the invention. More particularly, FIG. 4 illustrates interactions between one node 1 and a user agent 2 in order to generate and store recovery information regarding a share of a cryptographic key held by the node 1 in a storage 4. It should, however, be understood that the user agent 2 interacts in a similar manner with other nodes 1 holding other shares of the cryptographic key.

In the embodiment illustrated in FIG. 4, it is assumed that the nodes 1 hold an additive secret sharing of a cryptographic key, x, e.g. in the form of a private Elliptic Curve Digital Signal Algorithm (ECDSA) signing key. Each node 1 and the user agent 2 further holds the corresponding public verification key, Y=g^{x}. It is further assumed that the user owning the funds of the crypto currency wallet and the cryptographic key, x, has a user identity, UID.

It is further assumed that all involved parties agree on all public parameters. This includes parameters for the threshold wallet, in particular the number of nodes 1, public parameters for the ECDSA scheme, including description of the elliptic curve group and generator, g, the public key, Y, etc. It further includes public parameters for an applied public-key encryption scheme, including the encryption key, ek, and parameters for an applied zero-knowledge scheme, a and b.

In order to ensure that the user agent 2 has the correct public parameters, each node 1 may send these parameters to the user agent 2 and let the user agent 2 abort if it observes that the nodes 1 do not all agree on the parameters. Thereby it is ensured that the user agent 2 holds correct parameters, unless all of the nodes 1 are corrupt. Alternatively or additionally, the user agent 2 may obtain the parameters from an external reliable source, e.g. a blockchain.

In the embodiment illustrated in FIG. 4, the user agent 2 sends a recovery information request to each node 1. As described above, only one node 1, i.e. node N₁, is shown in FIG. 4. The recovery information request includes the user's identity, UID.

In response to the recovery information request, each node 1, with node index i and holding secret share xi, computes MSG=UID∥Y, where ∥ means string concatenation. Then it computes (Yᵢ, Cᵢ, ZKᵢ)=EncryptWithProof(xᵢ, ek, MSG), where EncryptWithProof is an algorithm that takes as input values xᵢ, ek, MSG and performs the following steps, where Enc is a standard public-key encryption scheme such as RSA-OAEP:
1.Generate a random polynomial, f, of degree a such that f(0)=xᵢ.
2. Compute vⱼ=f(j) for j∈{1, 2, . . . , b}.
3. Encrypt eⱼ=Encₖ(vⱼ, rⱼ), where rⱼ is the randomness used for encryption.
4. For j∈{1, 2, . . . , a}, compute the commitments yⱼ=g^{vj}.
5. Hash g^{xi}, e₁, . . . , e_{b}, y₁, . . . , yₐ, MSG into a subset F⊂{1, 2, . . . , b} of size a.
6. Output Yᵢ=g^{xi}, Cᵢ=(e₁, e₂, . . . , e_{b}) and ZKᵢ={(j, vⱼ, rⱼ): j∈F; y₁, . . . , yₐ}.

Each node 1 returns recovery information, Dᵢ=(Yᵢ, Cᵢ, ZKᵢ) to the user agent 2. The user agent 2 then computes MSG=UID∥Y and Vᵢ=IsProofValid(Dᵢ, ek, MSG) for each node 1 in order to verify validity of the received recovery information. If any Vᵢ is false, the user agent 2 aborts. Vᵢ is computed using an algorithm, IsProofValid which has Dᵢ, MSG, and ek as input, and true/false as output. The algorithm returns “true” if the ZK proof contained in Dᵢ is valid with respect to the encryption Cᵢ and the value Yᵢ contained in Dᵢ, as well as the public key ek and the value MSG, and false otherwise, and it performs the following steps:
1. Let e₁, . . . , e_{b}, y₁, . . . , yₐ be the encryptions and commitments contained in Dᵢ and ZKᵢ. Hash Y, e₁, . . . , e_{b}, y₁, . . . , yₐ, and MSG into a subset F⊂{1, 2, . . . , b} of size a.
2. Compute all b commitments y₁, . . . , y_{b} using interpolation “in the exponent”. This is possible since we have a+1 commitments: Yᵢ=g^{xi}=g^{f(0)} and yᵢ=g^{f(i)} for 1≤i≤a.
3. Return true if for all j∉F there is no value (j, ·,·) in ZK and for all j∈F there is a value (j, vⱼ, rⱼ) in ZK such that eⱼ=Eₑₖ(vⱼ, rⱼ) and yⱼ=g^{vj}; and false otherwise.

Once the user agent 2 has received messages D₁, D₂, . . . , Dₙ from all the two or more nodes 1, the user agent 2 aborts unless Y=RecombineInExp(Y₁, Y₂, . . . , Yₙ), where RecombineInExp is an algorithm which has g^{x1}, g^{x2}, . . . , g^{xn} as input and Y=g^{x} as output, and which uses the homomorphic properties of exponentiations to recombine the secret sharing in the exponent. The algorithm performs the following steps:
1. If it is a Shamir sharing, convert it to an additive sharing by multiplying each share with the public Lagrange coefficient.
2. Compute and output Y=Y₁Y₂ . . . Yₙ=g^{x1}g^{x2} . . . g^{xn}=g^{x1+x2+ . . . +xn}.

Finally, the user agent 2 stores the recovery information, D=(D₁, D₂, . . . , Dₙ) in the storage 4, unless the process was aborted.

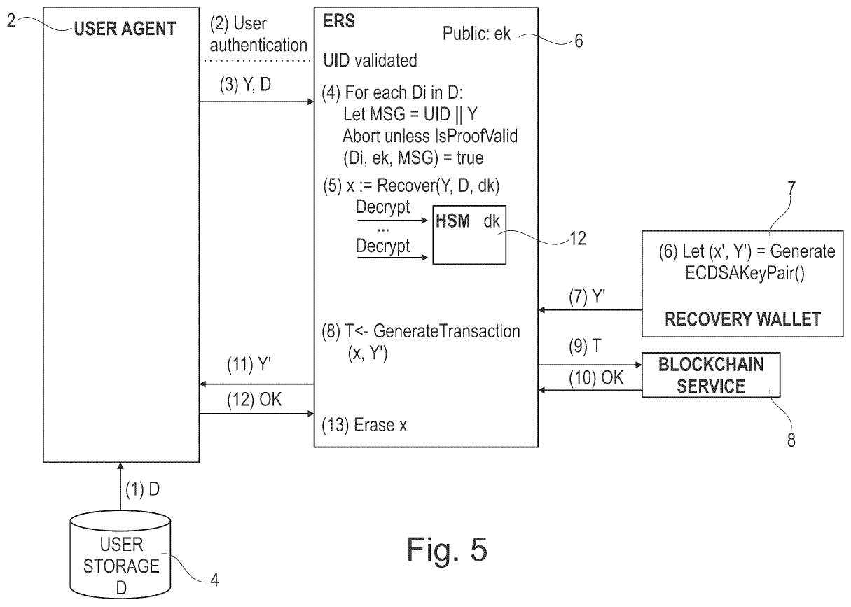

FIG. 5 illustrates an emergency recovery transaction in accordance with a method according to an embodiment of the invention. More particularly, FIG. 5 illustrates interactions between a user agent 2 and an emergency recovery service 6 in order to perform an emergency transaction of funds from a crypto currency wallet to a new crypto currency wallet 7, in the case that the crypto currency wallet and/or the corresponding cryptographic key has become in-operational.

In the embodiment illustrated in FIG. 5, the assumptions described above with reference to FIG. 4 also apply. Furthermore, it is assumed that the emergency recovery service 6 holds a private decryption key, dk, of the applied public-key encryption scheme, and that the user agent 2 holds the corresponding encryption key, ek. It is further assumed that the emergency recovery service 6 is able to validate the user identity, UID, via an external authentication mechanism. This could, e.g., include using an external identity provider, or the user could physically contact the emergency recovery service 6 and present suitable ID, e.g. a passport. Furthermore, it is assumed that the emergency recovery service 6 stores the decryption key, dk, in a hardware security module (HSM) 12 which only supports standard encryption, such as RSA-OAEP.

In the embodiment illustrated in FIG. 5, the user agent 2 retrieves recovery information, D, regarding the cryptographic key, x, from the storage 4, where it was previously stored, e.g. in the manner described above with reference to FIG. 4. The user agent 2 then authenticates at the emergency recovery service 6 with the user identity, UID, and by means of an external mechanism. This allows the emergency recovery service 6 to ensure that the user agent 2 has the correct UID. The user agent 2 uses the authenticated channel to provide the recovery information, D, as well as Y=g^{x} to the emergency recovery service 6.

For each of the individual messages, Dᵢ, of the recovery information, D, the emergency recovery service 6 computes MSG=UID∥Y and Vᵢ=IsProofValid(Dᵢ, ek, MSG), and aborts if Vᵢ=false. The algorithm IsProofValid was described above with reference to FIG. 4.

Once all Dᵢ are received, the emergency recovery service 6 computes x=Recover (Y, D, dk), where Recover is an algorithm which has Y, D=(D₁, D₂, . . . , Dₙ), and dk as input, and a cryptographic secret, x, as output. The algorithm performs the following steps:
1. For each Dᵢ:
a. For j=1 . . . b, where (j, ·, ·)∉Dᵢ.ZK
i. Compute vⱼ=Dec_{dk}(Dᵢ.C[j]), where C[j] is the j'th C-value in Dᵢ
ii. There are now a+1 v-values, so we can obtain xᵢ′=f(0) by Lagrange interpolation
iii. If Dᵢ.Y=^{g′} then go to step b
b. If xᵢ′ was found such that Dᵢ.Y=g^{xi′}, then let xᵢ=x′, otherwise abort
2. Compute x=X₁+x₂+ . . . +xₙ; if Y=g^{x} output x; otherwise abort.

It is noted that while the recovery algorithm is performed, dk remains in the HSM 12, and is only used for computing a number of standard RSA-OAEP decryptions.

A new crypto currency wallet 7 then generates a new key pair, (x′, Y′=g^{x′}), using a standard key generation algorithm. The new public key, Y′, is provided to the emergency recovery service 6, e.g. via an authentic channel.

The emergency recovery service 6 computes a signed blockchain transaction, T, based on the original private key, x, and the new public key, Y′, and using a standard algorithm. The blockchain transaction, T, moves all funds from the original crypto currency wallet to the new crypto currency wallet 7, i.e. from the address or addresses defined by x to the address defined by Y′. The blockchain transaction, T, is posted to the blockchain 8.

The emergency recovery service 6 waits until T is successfully confirmed on the blockchain 8, and then returns the new public key, Y′, to the user agent 2. The user agent 2 confirms receipt of the new public key, Y′, and the emergency recovery service 6 then erases the private key, x.

The embodiments illustrated in FIGS. 4 and 5 have the following advantages.

Except for the initial setting up of the system, where ek and dk are distributed, the emergency recovery service 6 is not involved in the process before recovery is needed.

The emergency recovery service 6 only needs to apply standard public-key decryption operations, e.g. RSA-OAEP. This is an advantage because, in many cases, the emergency recovery service 6 will store dk in a service or hardware security module (HSM) 12 which only provides standard operations.

Assuming that it holds the correct Y and ek, the user agent 2 can use the zero-knowledge proofs to validate that the recovery information is correct when it is received from the nodes 1. In particular, given that the user agent 2 holds correct versions of the public key, Y=g^{x}, and the encryption key, ek, the user agent 2 can check that the received recovery information contains correct encryptions under ek of values that can indeed be used for recovering the funds from the crypto currency wallet.

Given that the user agent 2 has the correct y and ek, the user agent 2 can validate the recovery data non-interactively, i.e. without any assistance from the nodes 1, and this can be done as often as desired. For instance, once every month it can be checked that the recovery information stored in the storage 4 is valid.

Given that y and ek are correct, the validity can be validated by the user agent 2, even if all of the nodes 1 are corrupted. This is stronger than the threshold guarantee, which usually assumes that at least one of the nodes 1 is honest.

The user needs not keep the recovery information, D, secret. If a malicious party steals the recovery information, D, the malicious party will not be able to misuse it, because only the emergency recovery service 6 holds the decryption key, dk, and because the malicious party will not be able to authenticate as a user towards the emergency recovery service 6 using the same UID, as the user. It is often easier to handle non-secret data, and it is easier to ensure its availability, e.g. in terms of backup, replication, etc.

The zero-knowledge proof is non-interactive. Accordingly, each node 1 only needs to send one message to the user agent 2, and the nodes I need not communicate further with each other.

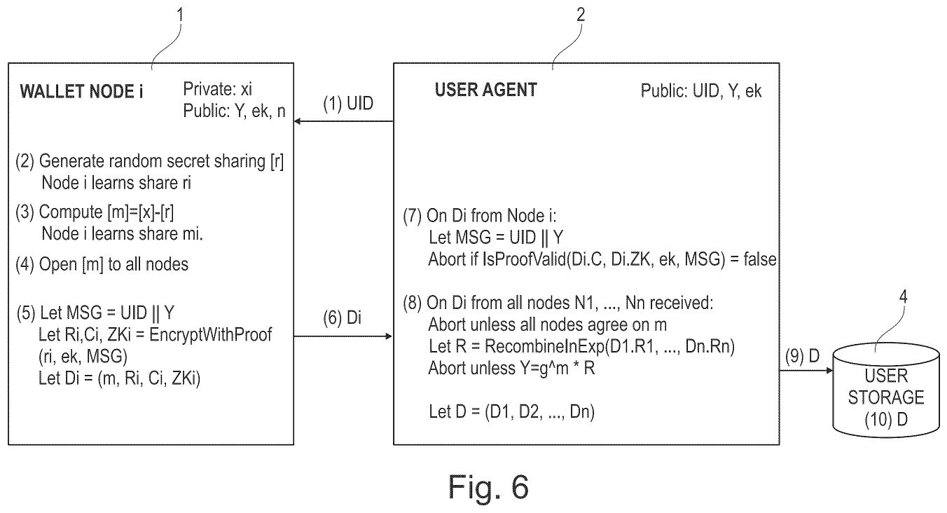

FIG. 6 illustrates storing of recovery information as part of performing a method according to an alternative embodiment of the invention. The method illustrated in FIG. 6 is very similar to the method illustrated in FIG. 4, and it will therefore not be described in detail here.

However, in the embodiment of FIG. 6, the recovery information is generated by means of secure multiparty computation among the nodes 1 of the wallet and the user agent 2. This is done in the following manner.

Initially, the nodes 1 hold a secret sharing [x] of the cryptographic key. They then use a secure multiparty computation to generate a random secret sharing, [r] and compute and open [m]=[x]−[r], such that each node 1 receives m without x or r being revealed to any particular node 1. Then the nodes 1 generate recovery information as in FIG. 4, except that they now use their shares of r instead of their shares of x as input. Each node i also sends m to the user agent 2. The user agent 2 validates each zero-knowledge proof it receives as in FIG. 4. Then, once all messages Di are received, the user agent 2 ensures that it has received the same m from all nodes 1, computes R using recombination “in the exponent”, and validates that Y=R·g^{m}. These steps prove to the user agent 2 that the combined recovery information, D, contains a value m and encryptions under the key ek of shares of a value r, such that the cryptographic key x is equal to m+r. Finally, the user agent 1 stores D in user storage 4.

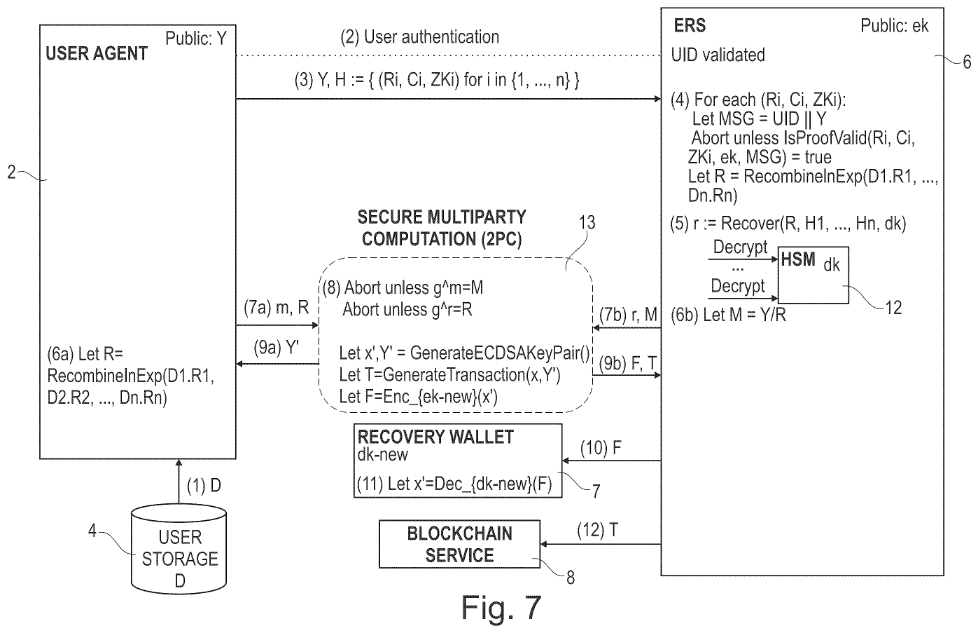

FIG. 7 illustrates an emergency recovery transaction in accordance with a method according to an alternative embodiment of the invention. The method illustrated in FIG. 7 is very similar to the method illustrated in FIG. 5, and it will therefore not be described in detail here.

However, in the embodiment illustrated in FIG. 7, the emergency transaction is performed by means of secure multiparty computation among the user agent 2 and the emergency recovery service 6.

In FIG. 7 we assume that the recovery data, D, is generated according to the method described in FIG. 6. When an emergency transaction is required, the user agent 2 does not provide m to the emergency recovery service 6. Accordingly, the user agent 2 holds m, and the emergency recovery service 6 holds r. This is an additive sharing of x, i.e. x=m+r. Furthermore, given Y, the user agent 2 and the emergency recovery service 6 can each compute a commitment, e.g. a Feldman commitment, to the other's share. More specifically, the user agent 2 can compute R=R₁·R₂ . . . Rₙ=g^{r1+r2+ . . . +rn}=g^{r} and the emergency recovery service 6 can compute

$$M = Y / R = {g}^{x} / {g}^{r} = {g}^{x - r} = {g}^{m} .$$

Such a sharing with commitments to the other's share is well-suited as input to a secure multiparty computation 13. The multiparty computation 13 can, e.g., compute a new ECDSA key pair (x′, Y′) and transfer the new private key x′ to the new cryptocurrency wallet 7, e.g. by wrapping the new private key x′ in a public key, pk-rec, obtained from the new cryptocurrency wallet 7.

In addition, the user agent 2 and the emergency recovery service 6 can now do a multiparty computation to sign a transaction, T, that recovers the funds from the crypto currency wallet. Computing T by means of the multiparty computation 13 allows both the user agent 2 and the emergency recovery service 6 to verify that T is of the correct amount, has the correct destination address, etc.

The user agent 2 receives the new public key, Y′, and the emergency recovery service 6 receives F and T, where F is the new private key x′ wrapped in a public key, pk-rec, and T is the transaction. The emergency recovery service 6 supplies F to the new crypto currency wallet 7, and the new crypto currency wallet 7 decrypts the new private key, x′, using dk-new. The emergency recovery service 6 posts the transaction, T, to the blockchain 8, thereby moving the funds to the new crypto currency wallet 7.

By applying the multiparty computation 13 in the emergency recovery process, it is obtained that neither the user agent 2, nor the emergency recovery service 6 learns x or x′ at the recovery time, and the multiparty computation ensures that the signed transaction T contains the correct amount and destination address, as long as at least one of the user agent 2 and the emergency recovery service 6 is honest.

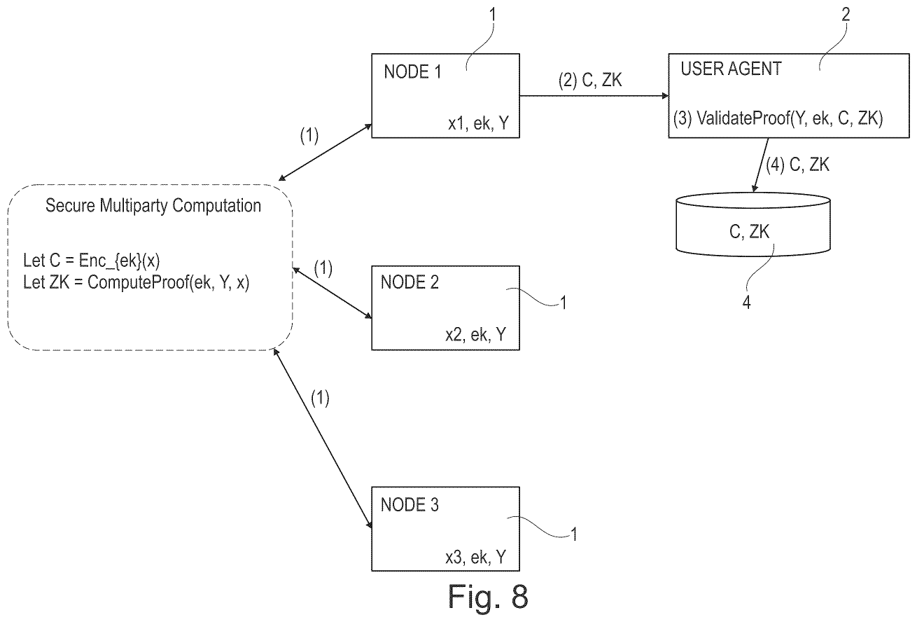

FIG. 8 illustrates recovery data generation using secure multiparty computation (MPC) among nodes 1 of a crypto currency wallet, in accordance with an embodiment of the invention. In FIG. 8, three nodes 1 are illustrated. It should, however, be noted that two nodes 1 or four or more nodes 1 could be applied.

The nodes 1 engage in a secure multiparty computation. As input each node uses its share, Xi, of the cryptographic key, x, the public encryption key, ek, of the emergency recovery service (not shown), and the public signing key, Y. The output of the computation is an encryption, C-Encₑₖ(x) and a non-interactive zero-knowledge proof, ZK, which proves that C and Y are consistent, i.e. that C is a correct encryption of x, using ek, and Y=g^{x}. The secure multiparty computation may include several rounds of communication between the nodes 1.

One of the nodes 1 provides (C, ZK) to the user agent 2, and the user agent 2 validates the proof. Finally, the user agent 2 stores recovery information in the form of C and ZK in the storage 4.

When an emergency transaction is subsequently required, this may be performed in the following manner. The user agent 2 retrieves D=(C, ZK) from the storage 4 and provides D to the emergency recovery service. The emergency recovery service then decrypts C, using dk, in order to obtain x, computes (x′, Y′) and a transaction, T, which moves the funds from x to Y′, posts T to the blockchain, imports x′ to a new crypto currency wallet, and finally deletes x.

One advantage of the embodiment illustrated in FIG. 8 is that the user agent 2 only needs to receive data (C and ZK) from a single node 1, and it is not necessary to send this data over a secure channel. Another advantage is that the recovery information now consists only of a single encryption of the value x instead of encryptions of each share of x.

1-14. (canceled)

15. A method for performing an emergency recovery transaction of funds from a crypto currency wallet, the method comprising the steps of:
providing a distributed cryptographic key being shared among two or more nodes with each node holding a share of the cryptographic key and none of the nodes holding the entire cryptographic key, the cryptographic key providing access to the funds of the crypto currency wallet,
storing recovery information regarding the cryptographic key in a storage being separate from the two or more nodes,
in the case that the cryptographic key and/or the wallet becomes in-operational, a user retrieving the recovery information from the storage and providing at least part of the retrieved recovery information to an emergency recovery service, and
the emergency recovery service and the user in cooperation performing an emergency recovery transaction of funds from the crypto currency wallet to a new crypto currency wallet, based on the recovery information, by the emergency recovery service and the user together running an interactive Secure Multiparty Computation (MPC) protocol.

16. The method according to claim 15, wherein the step of the emergency recovery service and the user in cooperation performing an emergency recovery transaction comprises the steps of:
the emergency recovery service generating a one-time cryptographic transaction key, based on the received recovery information, and
the emergency recovery service performing an emergency recovery transaction of funds from the crypto currency wallet to a new crypto currency wallet, using the one-time cryptographic transaction key.

17. The method according to claim 15, wherein the recovery information is in the form of pre-signatures generated by the nodes based on the shares of the cryptographic key held by the nodes.

18. The method according to claim 15, wherein the step of the user providing at least part of the retrieved recovery information to the emergency recovery service comprises the step of proving the identity of the user towards the emergency recovery service.

19. The method according to claim 18, wherein the recovery information comprises information regarding a unique identity of the user, and
wherein the step of proving the identity of the user towards the emergency recovery service comprises the step of the user proving ownership of the unique identity.

20. The method according to claim 19, wherein the unique identity is cryptographically linked to the recovery information.

21. The method according to claim 20, wherein the recovery information comprises a zero-knowledge proof which includes the unique identity of the user.

22. The method according to claim 20, wherein the user identity is linked to the recovery information using a digital signature.

23. The method according to claim 15, further comprising the steps of:
the two or more nodes providing encrypted versions of their shares of the cryptographic key to each other, and
the two or more nodes verifying the encrypted shares of the cryptographic key, and
wherein the step of storing recovery information regarding the cryptographic key in the storage comprises each of the nodes providing the encrypted version of its share of the cryptographic key to the storage in the case that the zero-knowledge proofs are valid.

24. The method according to claims 15, further comprising the step of the two or more nodes creating an encrypted version of the cryptographic key, based on the shares of the cryptographic key and using a multiparty encryption process, and
wherein the step of storing recovery information regarding the cryptographic key in the storage comprises storing the encrypted version of the cryptographic key in the storage.

25. The method according to claim 24, wherein the encrypted version of the cryptographic key comprises a zero-knowledge proof, and
wherein the step of storing recovery information regarding the cryptographic key in the storage comprises verifying the zero-knowledge proof prior to storing the encrypted version of the cryptographic key.

26. The method according to claim 15, further comprising the step of providing a master chain code and storing the master chain code at the two or more nodes, and
wherein the step of storing recovery information regarding the cryptographic key in the storage comprises storing an encrypted version of the master chain code as part of the recovery information.

27. The method according to claim 26, wherein the distributed cryptographic key and the master chain code are derived from a common master seed, and
wherein the step of storing recovery information comprises storing an encrypted version of the common master seed.

28. The method according to claim 26, further comprising the step of the user verifying the retrieved recovery information by verifying correspondence between the cryptographic key and the master chain code.
